(19) United States
(12) Patent Application Publication
(10) Pub. No.: US 2026/0101127 A1
(43) Pub. Date: Apr. 9, 2026

(54) IMAGE SENSING DEVICE

(71) Applicant: SK hynix Inc., Icheon-si Gyeonggi-do (KR)

(72) Inventors: Jeong Ik CHOI, Icheon-si Gyeonggi-do (KR); Gun Hee YUN, Icheon-si Gyeonggi-do (KR); Hoe Sam JEONG, Icheon-si Gyeonggi-do (KR)

(73) Assignee: SK hynix Inc., Icheon-si Gyeonggi-do (KR)

(21) Appl. No.: 19/201,546

(22) Filed: May 7, 2025

(30) Foreign Application Priority Data
Oct. 8, 2024 (KR) 10-2024-0136915

(51) Int. Cl. H04N 25/773; H04N 25/771; H04N 25/78

(52) U.S. Cl. CPC H04N 25/773; H04N 25/771; H04N 25/78

(57) ABSTRACT

An image sensing device includes a pixel array including a plurality of pixels connected to a plurality of row lines and a plurality of column lines and configured to output a plurality of pixel signals through the plurality of column lines; a ramp generator configured to generate a first ramp signal and a second ramp signal; an analog-to-digital converter (ADC) configured to convert the plurality of pixel signals into digital signals in response to the first ramp signal and the second ramp signal; and a column line controller configured to selectively connect the plurality of column lines to the ADC.

### CROSS-REFERENCE TO RELATED APPLICATION

The present application claims priority under 35 U.S.C. § 119(a) to Korean patent application number 10-2024-0136915, filed on Oct. 8, 2024, in the Korean Intellectual Property Office, which application is incorporated herein by reference in its entirety.

### BACKGROUND

### 1. Technical Field

The present disclosure generally relates to an image sensing device that generates image data.

### 2. Related Art

Complementary Metal Oxide Semiconductor (CMOS) Image Sensors (CIS) have lower power consumption, lower costs, and smaller size than comparable products. CMOS image sensors are in widespread use. CMOS image sensors have higher image quality than comparable products, such that the application of CMOS image sensors extends to video applications that utilize higher resolution and higher frame rate compared to other products.

Different from a solid state image pickup device, CMOS image sensors convert analog signals (pixel signals) generated from a pixel array into digital signals. To convert analog signals into digital signals, the CMOS image sensors include a high-resolution Analog-to-Digital Converter (ADC).

### SUMMARY

In accordance with an embodiment of the present disclosure, an image sensing device may include: a pixel array including a plurality of pixels connected to a plurality of row lines and a plurality of column lines, and configured to output a plurality of pixel signals through the plurality of column lines; a ramp generator configured to generate a first ramp signal and a second ramp signal; an analog-to-digital converter (ADC) configured to convert the plurality of pixel signals into digital signals in response to the first ramp signal and the second ramp signal; and a column line controller configured to selectively connect the plurality of column lines to the ADC.

In accordance with an embodiment of the present disclosure, an image sensing device may include: a first pixel configured to output a first pixel signal through a first column line; a second pixel configured to output a second pixel signal through a second column line; a switching circuit that selectively connects, based on a switching control signal, the first column line to one of a first node and a second node and selectively connects, based on the switching control signal, the second column line to one of the first node and the second node; a first ramp generator configured to generate a first ramp signal; a second ramp generator configured to generate a second ramp signal; a first conversion circuit configured to compare the first ramp signal with a signal applied to the first node, amplify a result of the comparison, and generate a first output signal; and a second conversion circuit configured to compare the second ramp signal with a signal applied to the second node, amplify a result of the comparison, and generate a second output signal.

### BRIEF DESCRIPTION OF THE DRAWINGS

FIG. 1 is a block diagram illustrating an example of an imaging device according to an embodiment of the present disclosure.

FIG. 2 is a diagram illustrating an example of a pixel array and a row driver according to an embodiment of the present disclosure.

FIG. 3A to FIG. 3D are diagrams illustrating a pixel array and a row driver during example operations according to an embodiments of the present disclosure.

FIG. 4 is a circuit diagram illustrating an example of a column line selector and an analog-to-digital converter according to an embodiment of the present disclosure.

FIG. 5 is a circuit diagram illustrating a column line selector and an ADC during example operations according to an embodiment of the present disclosure.

FIG. 6 is a diagram illustrating an example of a ramp generator according to an embodiment of the present disclosure.

FIG. 7 is a circuit diagram illustrating an example of a pixel array, a column line selector, and an ADC included according to an embodiment of the present disclosure.

FIG. 8 is a circuit diagram illustrating a column line selector and an ADC during example operations according to an embodiment of the present disclosure.

### DETAILED DESCRIPTION

The present disclosure includes examples of an image sensing device capable of generating image data and performing image conversion. The present disclosure describes an image sensing device capable of reducing horizontal noise by removing ramp noise. An image sensing device according to the present disclosure can improve noise characteristics of the image sensor by reducing horizontal noise.

An ADC performs correlated double sampling about an analog output voltage indicating an output signal of the pixel array and stores the resulting voltage. In response to a ramp signal generated by the ramp signal generator, the ADC compares the stored voltage obtained by the correlated double sampling operation with a predetermined reference voltage referred to as a ramp signal, such that the ADC provides a comparison signal for generating a digital code. Because the ramp signal generator generates the ramp signal based on a power-supply voltage, power noise or noise from the ramp signal generator may be included in the ramp signal and output. Such noise may cause increased horizontal noise in a CMOS image sensor. A method for efficiently reducing horizontal noise is advantageous in a high-resolution and high-speed CMOS image sensor.

Embodiments of the present disclosure are described in detail with reference to the accompanying drawings. Specific structural or functional descriptions of embodiments are provided as examples to describe concepts that are disclosed in the present application. Examples or embodiments in accordance with the concepts may be carried out in various forms, and the scope of the present disclosure is not limited to the examples or embodiments described in this specification.

When one component is identified as “connected” to another component, the components may be connected directly or through an intervening component between the components. When two components are identified as “directly connected,” one component is directly connected to the other component without an intervening component between the two components.

Terms such as “horizontal,” “above,” “side,” “higher,” “high,” “low,” “left,” “right,” “column,” “row,” “level,” and other terms implying relative spatial relationship or orientation are utilized only for the purpose of ease of description or reference to a drawing and are not otherwise limiting.

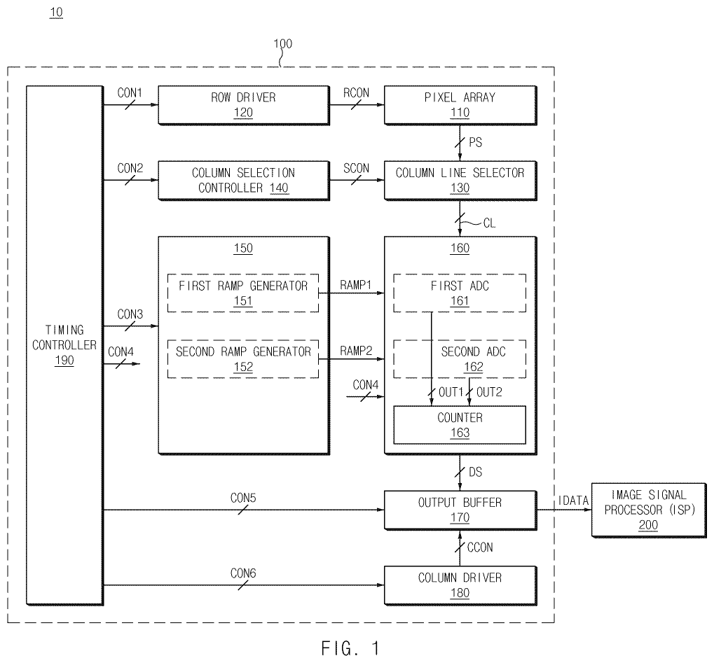

FIG. 1 is a block diagram illustrating an example of an imaging device 10 according to an embodiment of the present disclosure.

Referring to FIG. 1, the imaging device 10 includes, for example, a digital still camera that photographs or captures still images or a digital video camera that photographs or captures moving images. For example, the imaging device 10 may be implemented as a Digital Single Lens Reflex (DSLR) camera, a mirrorless camera, or a smartphone, and so forth. The imaging device 10 includes a device having both a lens and an image pickup element such that the device captures or photographs a target object and creates an image of the target object.

The imaging device 10 includes an image sensing device 100 and an image signal processor (ISP) 200.

The image sensing device 100 may be a complementary metal oxide semiconductor image sensor (CIS) that converts incident light into an electrical signal. The image sensing device 100 includes a pixel array 110, a row driver 120, a column line selector 130, a column selection controller 140, a ramp generator 150, an analog-to-digital converter (ADC) 160, an output buffer 170, a column driver 180, and a timing controller 190. The components of the image sensing device 100 illustrated in FIG. 1 are examples, and the present disclosure is not limited to the components and interconnections shown in FIG. 1.

The pixel array 110 includes a plurality of pixels arranged in rows and columns. In one example, the plurality of pixels is arranged in a two-dimensional 2D pixel array including rows and columns. In another example, the plurality of pixels is arranged in a three dimensional pixel array. The plurality of pixels converts optical signals or incident light into electrical signals on a pixel basis or a pixel group basis and outputs a pixel signal PS. The pixels in a pixel group of the pixel array 110 share at least one circuit. The pixel array 110 receives driving signals RCON, including a row line selection signal, a pixel reset signal, a transfer signal, and so forth from the row driver 120. Upon receiving the driving signals RCON, (imaging) pixels in the pixel array 110 are activated to perform the operations corresponding to the row line selection signal, the pixel reset signal, and the transfer signal.

For example, the row driver 120 activates the pixel array 110, based on commands and control signals provided by the timing controller 190, to perform one or more operations on the pixels included in a corresponding row. For example, the row driver 120 selects one or more pixels arranged in one or more rows of the pixel array 110. The row driver 120 generates a row line selection signal to select one or more rows among the plurality of rows. In an embodiment, the row driver 120 generates a row line selection signal that selects a pair of consecutive row lines among a plurality of row lines.

The row driver 120 sequentially enables the pixel reset signal that resets the pixels corresponding to at least one selected row and the transfer signal for the pixels corresponding to the at least one selected row. Thus, a reference signal and an image signal, which are analog signals generated by each of the pixels of the selected row, are sequentially transferred to the ADC 160. The reference signal is an electrical signal provided to the ADC 160 when a sensing node of a pixel, such as a floating diffusion region, is reset, and the image signal is an electrical signal provided to the ADC 160 when photoelectrons, photons, or photocharges generated by the pixel are accumulated at the sensing node. The reference signal indicating unique reset noise of each pixel and the image signal indicating the intensity of incident light may be collectively referred to as a pixel signal PS.

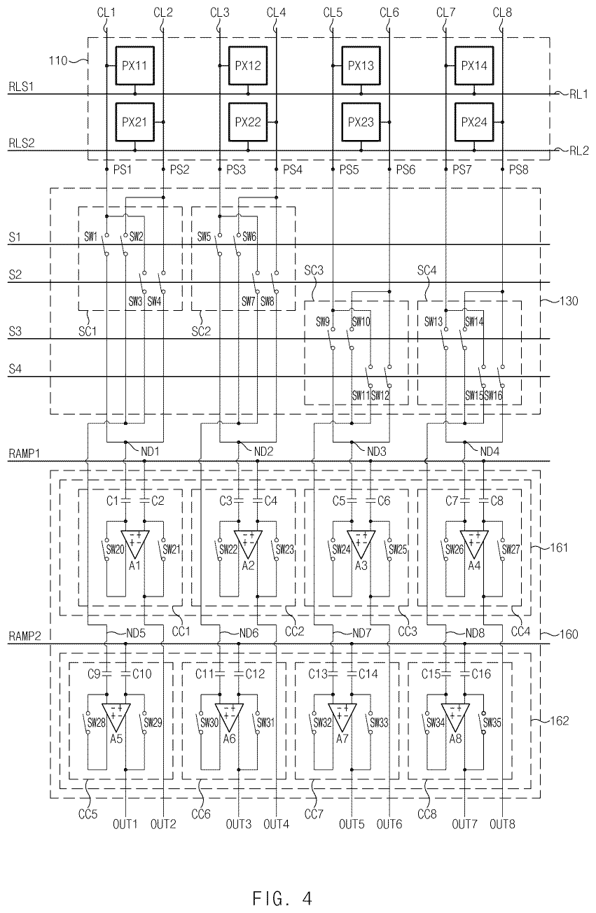

The column line selector 130 selectively connects a column line CL receiving the pixel signal PS to the ADC 160 based on a selection control signal SCON received from the column selection controller 140. For example, the column line selector 130 connects a first of a pair of column lines CL selected by the selection control signal SCON from among the plurality of column lines CL to a first ADC 161 and connects a second of the pair of column lines CL to a second ADC 162. A detailed connection structure of the column line selector 130 is described with reference to FIG. 4.

The column selection controller 140 generates a selection control signal SCON that selectively controls connection of the plurality of column lines CL based on a control signal CON3 received from the timing controller 190. For example, the column selection controller 140 controls one pair of consecutive column lines from among the plurality of column lines CL for selection. For convenience of description, the column selection controller 140 is illustrated as a separate component, although the present disclosure is not limited to this example. For example, the column selection controller 140 may be included within the timing controller 190.

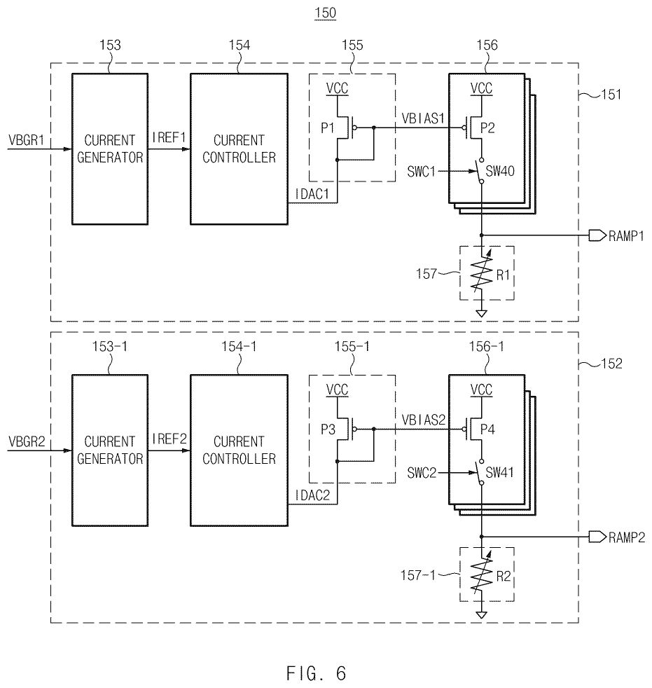

The ramp generator 150 outputs a first ramp signal RAMP1 and a second ramp signal RAMP2 utilized during analog-to-digital conversion operation of the ADC 160 in response to a control signal CON3 received from the timing controller 190. The ramp generator 150 includes a first ramp generator 151 and a second ramp generator 152. The first ramp generator 151 generates a first ramp signal RAMP1 based on a control signal CON3. The second ramp generator 152 generates a second ramp signal RAMP2 based on the control signal CON3. A detailed configuration of the ramp generator 150 is described with reference to FIG. 6.

In an example of the present disclosure, the ramp generator 150 includes two ramp generators 151, 152, although the present disclosure is not limited to this example. The quantity of ramp generators may be three or more, and the quantity of noise generators may vary.

CMOS image sensors use correlated double sampling CDS to remove undesired offset values of pixels known as the fixed pattern noise by sampling a pixel signal PS twice to remove the difference between these two samples. In one example, correlated double sampling CDS removes the undesired offset value of pixels by comparing pixel output voltages obtained before and after photoelectrons, photons, or photocharges generated by incident light are accumulated at the sensing node such that pixel output voltages based solely on the incident light are measured.

In an embodiment of the present disclosure, the ADC 160 sequentially samples and holds voltage levels of the reference signal and the image signal provided to each of a plurality of column lines from the pixel array 110. The ADC 160 may be a ramp-compare type ADC that uses the ramp output signal of the ramp generator 150. The ADC 160 samples and holds a pixel signal PS for each column output from each column line CL of the pixel array 110, converts the pixel signal into a digital signal DS, and outputs the digital signal DS.

According to an embodiment, the ADC 160 includes a first ADC 161, a second ADC 162, and a counter 163. In an example, the ADC 160 is implemented with two ADCs, although the present disclosure is not limited to this example. The quantity of ADCs may be three or more, and the quantity of ADCs may vary.

The first ADC 161 receives the first ramp signal RAMP1 and the pixel signal PS output from a column line CL selected by the column line selector 130 and transmits an output signal OUT1 to the counter 163. The second ADC 162 receives the second ramp signal RAMP2 and the pixel signal PS output from the column line CL selected by the column line selector 130 and transmits an output signal OUT2 to the counter 163. A detailed connection structure of the ADC 160 is described with reference to FIG. 4.

The counter 163 performs a counting operation until each of the ramp signals RAMP1, RAMP2 matches the analog pixel signal PS. The counter 163 counts each instance of a feature of the received output signals OUT1, OUT2, such as a rising edge that occurs when the output signals OUT1, OUT2 transition from a logic low level to a logic high level and outputs the counting result as the digital signal DS. Other features, such as a falling edge, may be counted. The counting value of the counter 163 is initialized in response to a control signal CON4.

For example, the output buffer 170 temporarily holds and outputs the column-based image data, such as data IDATA, obtained by analog-to-digital conversion of the pixel signal provided from the ADC 160. In one example, the output buffer 170 temporarily stores the image data IDATA received from the ADC 160 based on a control signal CON5 from the timing controller 190. The output buffer 170 is an interface that compensates for data rate differences or transfer rate differences between the image sensing device 100 and other devices.

Upon receiving a control signal from the timing controller 190, the column driver 180 selects a column of the output buffer and sequentially outputs the image data IDATA temporarily stored in the selected column of the output buffer 170. In an embodiment, upon receiving an address signal from the timing controller 190, the column driver 180 generates a column selection signal CCON based on the address signal and selects a column of the output buffer 170 such that the image data IDATA is output as an output signal from the selected column of the output buffer 170.

In an embodiment, the timing controller 190 controls at least one of the row driver 120, the row selection controller 140, the ramp generator 150, the ADC 160, the output buffer 170, and the column driver 180.

In an embodiment, the timing controller 190 provides the row driver 120, the column selection controller 140, the ramp generator 150, the ADC 160, the output buffer 170, and the column driver 180 with a clock signal utilized to facilitate operation of the components of the image sensing device 100, a control signal that controls timing, and address signals that select a row or column. In an embodiment of the present disclosure, the timing controller 190 includes a logic control circuit, a phase-locked loop (PLL) circuit, a timing control circuit, a communication interface circuit, and so forth.

The image signal processor ISP 200 performs image processing on image data received from the image sensing device 100. The image signal processor ISP 200 reduces noise within image data, and performs various kinds of image signal processing, for example, interpolation, synthesis, gamma correction, color filter array interpolation, color matrix, color correction, color enhancement, lens distortion correction, and so forth, to improve image-quality of the image data IDATA. The image signal processor ISP 200 compresses image data created during image signal processing to improve image-quality such that the image signal processor ISP 200 creates an image file using the compressed image data. Alternatively, the image signal processor ISP 200 recovers image data from the image file. In this example, the scheme or format that compresses such image data may be a reversible format or an irreversible format. As a representative example of such compression format, in the example of a still image, the Joint Photographic Experts Group (JPEG) format, JPEG 2000 format, or the like may be used. In the example of moving images, a plurality of frames may be compressed according to the Moving Picture Experts Group (MPEG) standard such that moving image files are created. For example, the image files may be created according to the Exchangeable image file format (Exif) standard.

The image signal processor ISP 200 may transmit the ISP image data to a host device (not shown). The host device may be a processor, for example, an application processor, that processes the ISP image data received from the image signal processor ISP 200, a memory, for example, a non-volatile memory, that stores the ISP image data, or a display device, for example, a liquid crystal display (LCD), that visually displays the ISP image data. The image signal processor ISP 200 transmits control signals to the image sensing device 100 to control operations, for example, whether or not to operate, operation timing, operation mode, and so forth, of the image sensing device 100.

Because the ramp generator 150 generates a ramp signal based on a power-supply voltage or a ground voltage, power noise or ground noise is included in the ramp signal as is, and the resulting ramp signal including such noise is output. Noise (referred to as “ramp noise”) generated by the ramp generator 150 may also be included in the ramp signal without filtering, such that the resulting ramp signal including noise is output. Such noise may increase horizontal noise in the CMOS image sensor CIS.

According to an embodiment, the ramp generator 150 includes a first ramp generator 151 and a second ramp generator 152, the ADC 160 includes a first ADC 161 and a second ADC 162, the first ramp generator 151 is connected to the first ADC 161, and the second ramp generator 152 is connected to the second ADC 162. Thus, each of the two ramp signals RAMP1, RAMP2 is correlated with one of the two ADCs 161, 162. The column line selector 130 selectively connects each column line to one of the first ADC 161 and the second ADC 162.

A noise level of the ramp generator 150 may be obtained as a value of the root mean square RMS of the noise. The output signals OUT1, OUT2 of the first ADC 161 and the second ADC 162 may be summed and averaged or the standard deviation of the output signals OUT1, OUT2 of the first ADC 161 and the second ADC 162 may be measured such that the degree of noise, such as horizontal noise, generated in a horizontal direction is measured.

When the RMS values of noise generated by the ramp generators 151, 152 are equal, and the ramp signals RAMP1, RAMP2 are independently correlated with the two ADCs 161, 162, horizontal noise can be reduced.

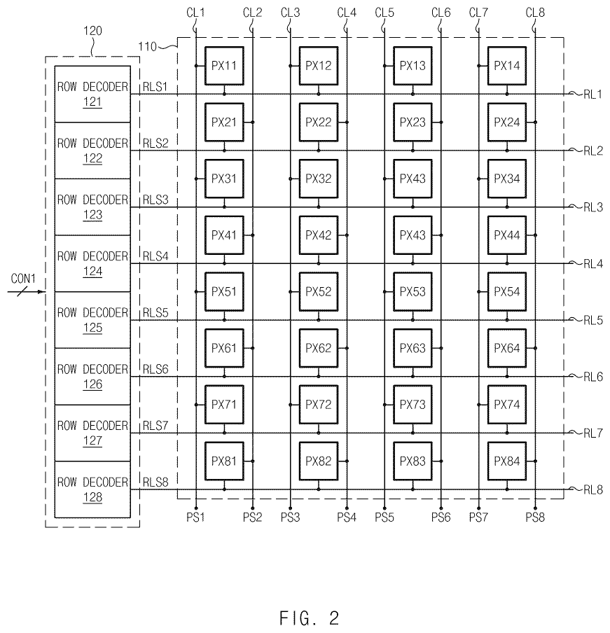

FIG. 2 is a diagram illustrating the pixel array 100 and the row driver 120, for example, as shown in FIG. 1, according to an embodiment of the present disclosure.

Referring to FIG. 2, the pixel array 110 includes a plurality of pixels PX11 to PX14, PX21 to PX24, PX31 to PX34, PX41 to PX44 arranged in the row and column directions. The plurality of pixels PX11 to PX14, PX21 to PX24, PX31 to PX34, PX41 to PX44 are connected between a plurality of row lines RL1 to RL8 and a plurality of column lines CL1 to CL8.

Although the pixel array 110 includes eight row lines RL1 to RL8 and eight column lines CL1 to CL8, the present disclosure is not limited to this example. The quantity of row lines and the quantity of column lines may vary.

In the pixel array 110, pixels provided in one column are alternately connected to a column line (referred to as a left column line) arranged on the left side and another column line (referred to as a right column line) arranged on the right side based on the positions of the pixels. In one column, odd pixels are connected to the left column line, and even pixels are connected to the right column line.

For example, the pixels PX11, PX21, PX31, PX41, PX51, PX61, PX71, PX81 located in the first column output a pair of pixel signals PS1, PS2 on a pair of column lines CL1, CL2. The pixels PX11, PX21, PX31, PX41, PX51, PX61, PX71, PX81 are arranged consecutively in the first column. The column lines CL1, CL2 are arranged on both sides of the pixels PX11, PX21, PX31, PX41, PX51, PX61, PX71, PX81 located in the first column. The first pixel PX11 in the first column is connected to a row line RL1 and a left column line CL1. The second pixel PX21 of the first row is connected to the row line RL2 and the right column line CL2.

The pixels PX12, PX22, PX32, PX42, PX52, PX62, PX72, PX82 located in the second column output a pair of pixel signals PS3, PS4 on a pair of column lines CL3, CL4. The pixels PX12, PX22, PX32, PX42, PX52, PX62, PX72, PX82 are arranged consecutively in the second column. The column lines CL3, CL4 are arranged on both sides of the pixels PX12, PX22, PX32, PX42, PX52, PX62, PX72, PX82 located in the second column. The first pixel PX12 of the second column is connected to the row line RL1 and the left column line CL3. The second pixel PX22 of the second column is connected to the row line RL2 and the right column line CL4. The pixels of the other columns included in the pixel array 110 are connected to the column lines and the row lines in a similar manner as shown in FIG. 2.

The row driver 120 includes a plurality of row decoders 121 to 128 that select the row lines RL1 to RL8, respectively, in the pixel array 110. The plurality of row decoders 121 to 128 selectively output a plurality of row line selection signals RLS1 to RLS8 based on a control signal CON1 received from the timing controller 190. The plurality of row line selection signals RLS1 to RLS8 may be signals included in the driving signal RCON.

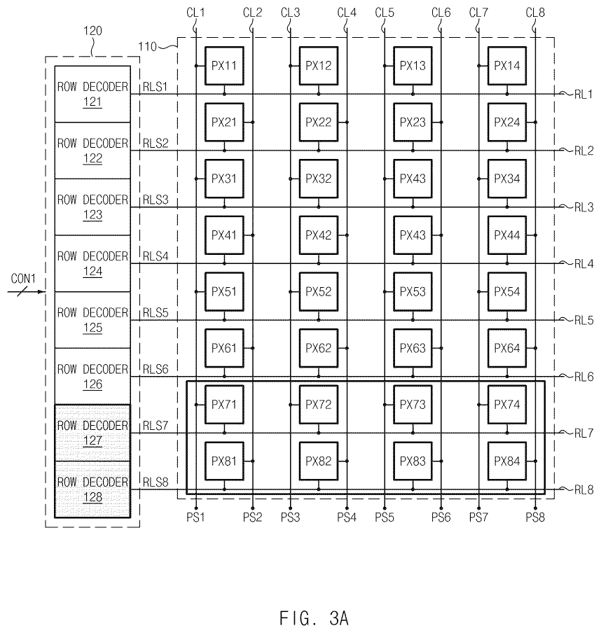

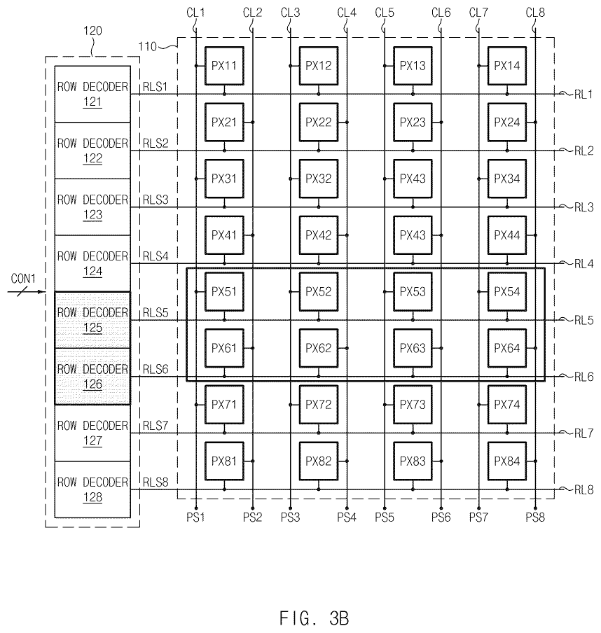

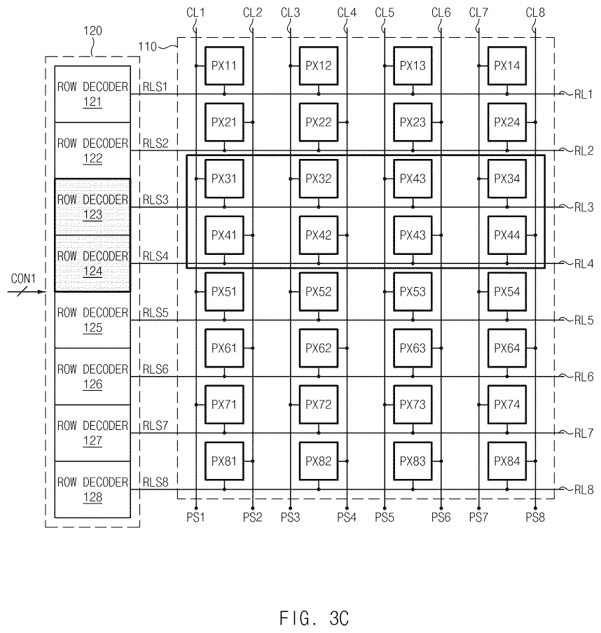

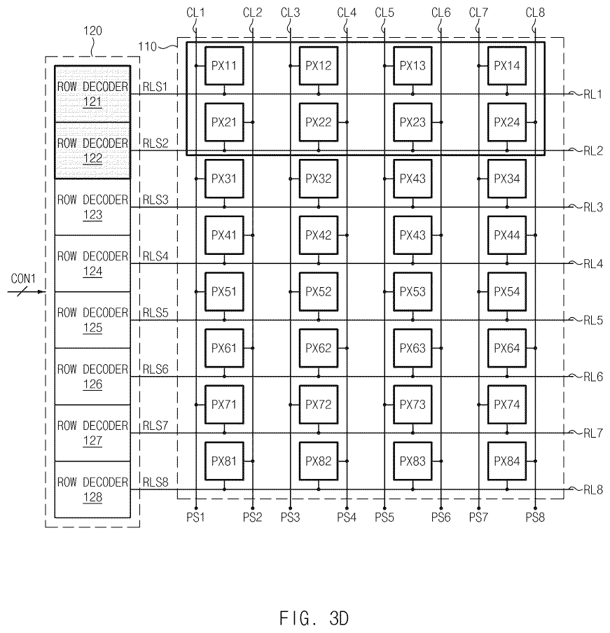

For example, when the row line selection signal RLS1 is activated or output by the row decoder 121, pixels PX11 to PX14 connected to the row line RL1 are selected. As another example, when the row line selection signal RLS2 is activated or output by the row decoder 122, pixels PX21 to PX24 connected to the row line RL2 are selected. The pixels of the other row lines RL3 to RL8 included in the pixel array 110 are selected in a similar manner. The operation of the row driver 120 is described with reference to FIG. 3A to FIG. 3D.

FIG. 3A to FIG. 3D are diagrams illustrating the pixel array 110 and the row driver 120, such as shown in FIG. 2, during example operations according to an embodiment of the present disclosure.

Referring to FIG. 3A to FIG. 3D, according to an embodiment of the present disclosure, a pair of consecutive row decoders among a plurality of row decoders 121 to 128 are activated simultaneously. When a pair of row decoders is activated simultaneously, one pair of consecutive row line selection signals from among a plurality of row line selection signals RLS1 to RLS8 are output or activated simultaneously. A plurality of row decoders 121 to 128 are activated on the basis of two row decoders, such as one pair of row decoders. The row decoders 121 to 128 are activated pairwise, two-by-two, or two at a time. A plurality of row line selection signals RLS1 to RLS8 may be sequentially activated pairwise or two at a time.

For example, as shown in FIG. 3A, when a pair of row decoders 127, 128 is activated during a time period T1, a pair of row line selection signals RLS7, RLS8 is activated. When a pair of row line selection signals RLS7, RLS8 is activated, a pair of row lines RL7, RL8 is selected and a total of eight pixels PX71 to PX74, PX81 to PX84 is activated. Accordingly, a pair of pixel signals PS1, PS2 is output through a column line CL1, a pair of pixel signals PS3, PS4 is output through a column line CL2, a pair of pixel signals PS5, PS6 is output through a column line CL3, and a pair of pixel signals PS7, PS8 is output through a column line CL4.

For example, as shown in FIG. 3B, when a pair of row decoders 125, 126 is activated during a time period T2, a pair of row line selection signals RLS5, RLS6 is activated. When a pair of row line selection signals RLS5, RLS6 is activated, a pair of row lines RL5, RL6 is selected and a total of eight pixels PX51 to PX54, PX61 to PX64 is activated. Accordingly, a pair of pixel signals PS1, PS2 is output through the first column line CL1, a pair of pixel signals PS3, PS4 is output through the second column line CL2, a pair of pixel signals PS5, PS6 is output through the third column line CL3, and a pair of pixel signals PS7, PS8 is output through the fourth column line CL4. As shown in FIG. 3C and FIG. 3D, a pair of pixel signals is output in similar manner during the time periods T3 and T4, respectively.

Each of the time periods T1 through T4 represents a time period during which the ADC 160 is activated. For example, during the time period T1, the ADC 160 performs the analog-to-digital AD conversion operation on the selected pixels PX71 to PX74 and PX81 to PX84. During the time period T2, the ADC 160 performs the AD conversion operation on the selected pixels PX51 to PX54 and PX61 to PX64. During the time period T3, the ADC 160 performs the AD conversion operation on the selected pixels PX31 to PX34 and PX41 to PX44. During the time period T4, the ADC 160 performs the AD conversion operation on the selected pixels PX11 to PX14 and PX21 to PX24.

Because the examples of FIG. 3A to FIG. 3D are configured to output a pair of pixel signals, for example, PS1, PS2, based on pixels, for example, PX11, PX21, provided in one column or a unit of one column, the method used in the examples of FIG. 3A to FIG. 3D may be referred to as a dual readout method.

In an example, the row decoders 121 to 128 are sequentially activated two-by-two or pairwise. For example, the row decoders 121 to 128 are sequentially activated in the order of the two row decoders 127, 128, the two row decoders 125, 126, the two row decoders 123, 124, and the two row decoders 121, 122. The present disclosure is not limited to this example, and the row decoders 121 to 128 may be sequentially activated in the order of the two row decoders 121, 122, the two row decoders 123, 124, the two row decoders 125, 126, and the two row decoders 127, 128. The row decoders may be selectively activated at random. The order of activating the row decoders 121 to 128 may vary.

FIG. 4 is a circuit diagram illustrating an example of the column line selector and an ADC, for example, as shown in FIG. 2, according to an embodiment of the present disclosure.

FIG. 4 is described as an example in which the row decoders 121, 122 are activated and the row lines RL1, RL2 are selected by a pair of row line selection signals RLS1, RLS2, such as shown in the examples of FIG. 2 and FIG. 3D.

Referring to FIG. 4, the column line selector 130 includes a plurality of switching circuits SC1 to SC4.

The plurality of switching circuits SC1 to SC4 are selectively switched by a plurality of switching control signals S1 to S4 to selectively output a plurality of pixel signals PS1 to PS8 to the first ADC 161 or the second ADC 162. The plurality of switching circuits SC1 to SC4 selectively connects the plurality of column lines CL1 to CL8 to the first ADC 161 or the second ADC 162 based on the plurality of switching control signals S1 to S4. The plurality of switching control signals S1 to S4 are signals included in the selection control signal SCON received from the column selection controller 140.

Based on the switching control signals S1, S2, the switching circuit SC1 controls a first of a pair of column lines CL1, CL2 for connection to the first ADC 161 while controlling a second of the pair of column lines CL1, CL2 for connection to the second ADC 162. The switching circuit SC1 includes a plurality of switching elements SW1 to SW4. The switching element SW1 selectively connects the column line CL1 to node ND1 based on the switching control signal S1, and the switching element SW2 selectively connects the column line CL2 to node ND5 based on the switching control signal S1. The switching element SW3 selectively connects the column line CL1 to the node ND5 based on the switching control signal S2, and the switching element SW4 selectively connects the column line CL2 to the node ND1 based on the switching control signal S2.

Based on the switching control signals S1, S2, the switching circuit SC2 controls a first of a pair of column lines CL3, CL4 for connection to the first ADC 161 while controlling a second of the pair of column lines CL3, CL4 for connection to the second ADC 162. The switching circuit SC2 includes a plurality of switching elements SW5 to SW8. The switching element SW5 selectively connects the column line CL3 to node ND2 based on the switching control signal S1, and the switching element SW6 selectively connects the column line CL4 to node ND6 based on the switching control signal S1. The switching element SW7 selectively connects the column line CL3 to the node ND6 based on the switching control signal S2, and the switching element SW8 selectively connects the column line CL4 to the node ND2 based on the switching control signal S2.

Based on the switching control signals S3, S4, the switching circuit SC3 controls a first of a pair of column lines CL5, CL6 for connection to the first ADC 161 while controlling a second of the pair of column lines CL5, CL6 for connection to the second ADC 162. The switching circuit SC3 includes a plurality of switching elements SW9 to SW12. The switching element SW9 selectively connects the column line CL5 to node ND3 based on the switching control signal S3, and the switching element SW10 selectively connects the column line CL6 to node ND7 based on the switching control signal S3. The switching element SW11 selectively connects the column line CL5 to the node ND7 based on the switching control signal S4, and the switching element SW12 selectively connects the column line CL6 to the node ND3 based on the switching control signal S4.

Based on the switching control signals S3, S4, the switching circuit SC4 controls a first of a pair of column lines CL7, CL8 for connection to the first ADC 161 while controlling a second of the pair of column lines CL7, CL8 for connection to the second ADC 162. The switching circuit SC4 includes a plurality of switching elements SW13 to SW16. The switching element SW13 selectively connects the column line CL7 to node ND4 based on the switching control signal S3, and the switching element SW14 selectively connects the column line CL8 to node ND8 based on the switching control signal S3. The switching element SW15 selectively connects the column line CL7 to the node ND8 based on the switching control signal S4, and the switching element SW16 selectively connects the column line CL8 to the node ND4 based on the switching control signal S4.

The first ADC 161 includes a plurality of conversion circuits CC1 to CC4. The second ADC 162 includes a plurality of conversion circuits CC5 to CC8.

The plurality of conversion circuits CC1 to CC4 compares the pixel signals applied to the nodes ND1 to ND4 with the first ramp signal RAMP1, generates output signals OUT2, OUT4, OUT6, OUT8 based on a result of the comparison, and transmits the output signals OUT2, OUT4, OUT6, OUT8, shown as OUT2 in FIG. 2, to the counter 163. The plurality of conversion circuits CC5 to CC8 compares the pixel signals applied to the nodes ND5 to ND8 with the second ramp signal RAMP2 and generates output signals OUT1, OUT3, OUT5, OUT7 based on a result of the comparison, and transmits the output signals OUT1, OUT3, OUT5, OUT7, shown as OUT1 in FIG. 2, to the counter 163.

The conversion circuit CC1 includes a plurality of capacitors C1, C2, a comparator A1, and a plurality of switching elements SW20, SW21.

The plurality of capacitors C1, C2 is disposed at the input stage of the conversion circuit CC1 to reduce a band of noise received through the node ND1 and the first ramp signal RAMP1. The plurality of capacitors C1, C2 performs a function including transmitting the amount of voltage change regardless of the direct current DC level of the input signal.

The comparator A1 compares the pixel signal PS received through the node ND1 with the first ramp signal RAMP1, amplifies the resulting comparison signal, and outputs the output signal OUT2 to the counter 163. One comparator A1 is provided for the pair of column lines CL1, CL2. According to an embodiment, the comparator A1 generates the output signal OUT2 at the logic high level when the second ramp signal VRAMP1 is greater than the pixel signal PS. The comparator A1 generates the output signal OUT2 at the logic low level when the first ramp signal VRAMP1 is less than the pixel signal PS. Thus, the output signal OUT2 represents the magnitude relationship between the first ramp signal VRAMP1 and the pixel signal PS.

A plurality of switching elements SW20, SW21 is included to facilitate an auto-zeroing operation of the comparator A1.

The auto-zeroing operation is performed according to an auto-zeroing signal AZ (not shown). For example, the auto-zeroing signal AZ is a signal included in a control signal CON4 generated by the timing controller 190. The auto-zeroing operation is an operation including performing adjustments between a voltage level of the first ramp signal RAMP1 and a voltage level of the pixel signal PS to compare the first ramp signal RAMP1 with the pixel signal PS. During a time period when the auto-zeroing signal AZ is at a logic high level, a plurality of switching elements SW20, SW21 are turned on to perform the auto-zeroing operation of the comparator A1.

The conversion circuit CC2 includes a plurality of capacitors C3, C4, a comparator A2, and a plurality of switching elements SW22, SW23. The conversion circuit CC3 includes a plurality of capacitors C5, C6, a comparator A3, and a plurality of switching elements SW24, SW25. The conversion circuit CC4 includes a plurality of capacitors C7, C8, a comparator A4, and a plurality of switching elements SW26, SW27. The conversion circuit CC5 includes a plurality of capacitors C9, C10, a comparator A5, and a plurality of switching elements SW28, SW29. The conversion circuit CC6 includes a plurality of capacitors C11, C12, a comparator A6, and a plurality of switching elements SW30, SW31. The conversion circuit CC7 includes a plurality of capacitors C13, C14, a comparator A7, and a plurality of switching elements SW32, SW33. The conversion circuit CC8 includes a plurality of capacitors C15, C16, a comparator A8, and a plurality of switching elements SW34, SW35.

In FIG. 4, the operations of the conversion circuits CC2 to CC8 are performed in the same manner as in the conversion circuit CC1.

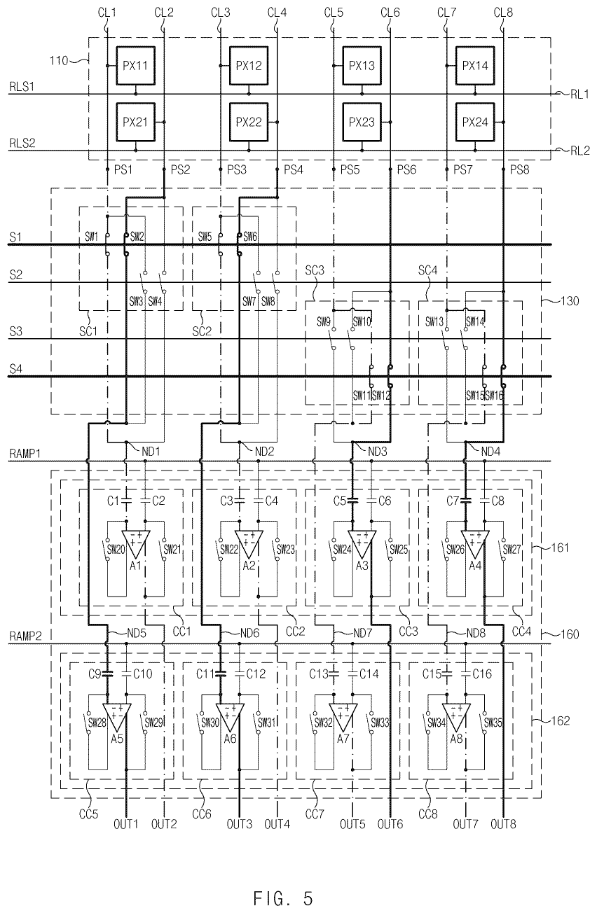

FIG. 5 is a circuit diagram illustrating the column line selector and the ADC, for example, as shown in FIG. 4, during example operations according to an embodiment of the present disclosure.

Referring to FIG. 5, during a time period, T1, during which the ADC 160 is activated, a first pair of switching control signals S1 and S4, for example, the switching control signals of a first group, from among the plurality of switching control signals S1 to S4, is activated while a second pair of switching control signals S2 and S3, for example, the switching control signals of a second group, is deactivated.

The present disclosure is not limited to this example, and the first pair of switching control signals S2, S3 among the plurality of switching control signals S1 to S4 is activated while the second pair of switching control signals S1, S4 is deactivated. In the example of FIG. 5, a first pair of switching control signals S1, S4 is activated while the second pair of switching control signals S2, S3 is deactivated.

Among the plurality of column lines CL1 to CL8, column lines CL1, CL3, CL5, CL7 are referred to as odd column lines, and column lines CL2, CL4, CL6, CL8 are referred to as even column lines.

When the switching control signals S1, S4 are activated and the switching control signals S2, S3 are deactivated as shown in the example of FIG. 5, the switching elements SW1, SW2, SW5, SW6, SW11, SW12, SW15, SW16 are turned on, and the switching elements SW3, SW4, SW7, SW8, SW9, SW10, SW13, SW14 are turned off.

Among the odd column lines CL1, CL3, CL5, CL7, a first pair of the column lines CL1, CL3 is connected to the first ADC 161, and a second pair of the column lines CL5, CL7 is connected to the second ADC 162. Among the even column lines CL2, CL4, CL6, CL8, a first pair of the column lines CL2, CL4 is connected to the second ADC 162 and a second pair of the column lines CL6, CL8 is connected to the first ADC 161.

Among a pair of consecutive column lines CL1, CL2, the odd column line CL1 is connected to the first ADC 161 and the even column line CL2 is connected to the second ADC 162. Among a pair of consecutive column lines CL3, CL4, the odd column line CL3 is connected to the first ADC 161, and the even column line CL4 is connected to the second ADC 162.

Among a pair of the consecutive column lines CL5, CL6, the odd column line CL5 is connected to the second ADC 162, and the even column line CL6 is connected to the first ADC 161. Among a pair of the consecutive column lines CL7, CL8, the odd column line CL7 is connected to the second ADC 162, and the even column line CL8 is connected to the first ADC 161.

The relationship between the ramp signals RAMP1, RAMP2 and the ADCs 161, 162 is described in the direction in which the column lines CL1 to CL8 are arranged. The column line CL1 is correlated with the first ramp signal RAMP1 and the first ADC 161, the column line CL2 is correlated with the second ramp signal RAMP2 and the second ADC 162, the column line CL3 is correlated with the first ramp signal RAMP1 and the first ADC 161, and the column line CL4 is correlated with the second ramp signal RAMP2 and the second ADC 162. The column line CL5 is correlated with the second ramp signal RAMP2 and the second ADC 162, the column line CL6 is correlated with the first ramp signal RAMP1 and the first ADC 161, the column line CL7 is correlated with the second ramp signal RAMP2 and the second ADC 162, and the column line CL8 is correlated with the first ramp signal RAMP1 and the first ADC 161.

In the relationship, the column lines CL1, CL3, CL6, CL8 connected to the first ADC 161 are the column lines of the first group, and the column lines CL2, CL4, CL5, CL7 connected to the second ADC 162 are the column lines of the second group. The output signals OUT2, OUT4, OUT6, OUT8 output through the column lines CL1, CL3, CL6, CL8 of the first group are the output signals of the first group, and the output signals OUT1, OUT3, OUT5, OUT7 output through the column lines CL2, CL4, CL5, CL7 of the second group are the output signals of the second group. The method of distributing and correlating the two ramp signals RAMP1, RAMP2 with the two ADCs 161, 162 may be referred to as a zigzag-patterned correlating method.

The image sensing device according to the present disclosure includes two ramp generators 151, 152 and two ADCs 161, 162, and a first pixel signal and a first ramp signal RAMP1 received from a pair of column lines are transmitted to the first ADC 161, or a second pixel signal and the second ramp signal RAMP2 are transmitted to the second ADC 162. Accordingly, the first ADC 161 receiving the first ramp signal RAMP1 is uncorrelated with the second ADC 162 receiving the second ramp signal RAMP2, resulting in reduction of horizontal noise.

FIG. 6 is a diagram illustrating an example of a ramp generator, for example, as shown in FIG. 1, according to an embodiment of the present disclosure.

Referring to FIG. 6, the first ramp generator 151 includes a current generator 153, a current controller 154, a voltage converter 155, a ramp signal generator 156, and a resistor circuit 157.

In this example, the current generator 153 generates a reference current IREF1 based on a band gap reference voltage VBGR1. In an example, the band gap reference voltage VBGR1 is a reference voltage having a constant voltage level with little fluctuation due to electrical load, time, or temperature change. In an example, the current generator 153 receives the band gap reference voltage VBGR1 from a band gap reference voltage circuit (not shown) located outside the first ramp generator 151. In an example, the current generator 153 receives a band gap reference voltage VBGR1 from a band gap reference voltage circuit (not shown) located in the timing controller 190.

In an example, the current generator 153 is a circuit that converts an input voltage into a current. For example, the current generator 153 includes an operational amplifier OP-AMP-based voltage-to-current converter, a transistor-based voltage-to-current converter, or an integrated circuit-based voltage-to-current converter.

The current controller 154 generates a digital-to-analog conversion DAC current IDAC1 based on the reference current IREF1. In an example, the DAC current IDAC1 is a reference current utilized to generate a bias voltage VBIAS1 used while performing the DAC operation for the first ramp signal VRAMP1. For example, the current controller 154 receives the reference current IREF1, adjusts the received reference current IREF1, and converts the adjusted reference current IREF1 into a DAC current IDAC1. The DAC current IDAC1 is a reference current that determines a ramp offset voltage and/or a swing width of the first ramp signal RAMP1. In an example, the current controller 154 includes a current mirror circuit and a current steering circuit.

The voltage converter 155 generates a bias voltage VBIAS1 based on the DAC current IDAC1. In an example, the bias voltage VBIAS1 determines a voltage level that is a reference value for the first ramp signal VRAMP1.

In an example, the voltage converter 155 is a circuit that converts an input current into a voltage. For example, the voltage converter 155 includes a resistor, an operational amplifier OP-AMP, a transistor, or an integrated circuit-based current-to-voltage converter. In an example, when the voltage converter 155 is a transistor-based current-to-voltage converter, the voltage converter 155 includes a transistor P1. The transistor P1 may be a PMOS transistor. The transistor P1 is connected between a power-supply voltage terminal and an input terminal of the DAC current IDAC1. The transistor P1 has a gate terminal commonly connected to a drain terminal.

The ramp signal generator 156 generates a first ramp signal VRAMP1 based on a bias voltage VBIAS1 and a switch control signal SWC1. The ramp signal generator 156 includes a transistor P2 and a switch SW40.

The transistor P2 selectively supplies a power-supply voltage VCC to the switch SW40 based on the bias voltage VBIAS1. The transistor P2 operates as a variable current source that adjusts a microcurrent provided to the switch SW40 in response to the bias voltage VBIAS1. The transistor P2 may be a PMOS transistor. The transistor P2 is connected between the power-supply voltage VCC terminal and the switch SW40 and receives the bias voltage VBIAS1 through a gate terminal.

The switch SW40 is connected between the transistor P2 and the resistor circuit 157, and the switching operation is selectively controlled by the switching control signal SWC1. In an example, the switching control signal SWC1 is included in the control signal CON3 generated by the timing controller 190.

According to an embodiment, the ramp signal generator 156 includes a plurality of ramp signal generators. The plurality of ramp signal generators 156 controls the first ramp signal RAMP1 by adjusting the quantity of switches SW40 connected according to the switching control signal SWC1.

The resistor circuit 157 controls loading of the ramp signal generator 156 that generates the first ramp signal RAMP1. The resistor circuit 157 includes a variable resistor R1, a resistance value of which varies to adjust an offset value, although the present disclosure is not limited to this example. The variable resistor R1 is connected between the switch SW40 and the ground voltage terminal such that the resistance is adjustable.

As the resistance of the resistor circuit 157 decreases, a gap, referred to as a swing width, between a maximum voltage level and a minimum voltage level of the first ramp signal VRAMP1 decreases. In an example, when the swing width of the first ramp signal VRAMP1 is relatively small, image data IDATA having a relatively large value for the same pixel signal is generated. Thus, the analog gain increases. As the resistance of the resistor circuit 157 increases, the swing width of the first ramp signal VRAMP1 increases. In an example, when the swing width of the first ramp signal VRAMP1 is relatively large, image data IDATA having a relatively small value for the same pixel signal is generated. Thus, the analog gain decreases.

The second ramp generator 152 includes a current generator 153-1, a current controller 154-1, a voltage converter 155-1, a ramp signal generator 156-1, and a resistor circuit 157-1.

The current generator 153-1 generates a reference current IREF2 based on a band gap reference voltage VBGR2. The current controller 154-1 generates a DAC current IDAC2 based on the reference current IREF2. The voltage converter 155-1 generates a bias voltage VBIAS2 based on the DAC current IDAC2. In an example, when the voltage converter 155-1 is a transistor-based current-to-voltage converter, the voltage converter 155-1 includes a transistor P3. The ramp signal generator 156-1 generates a second ramp signal VRAMP2 based on the bias voltage VBIAS2 and a switch control signal SWC2. The ramp signal generator 156-1 includes a transistor P4 and a switch SW41. The resistor circuit 157-1 includes a variable resistor R2.

The circuit and operation of the second ramp generator 152 may be similar to the circuit and operation of the first ramp generator 151.

When the circuits of the first ramp generator 151 and the second ramp generator 152 are the same, waveforms of the first ramp signal RAMP1 are similar or identical to waveforms of the second ramp signal RAMP2. Noise components generated by the first ramp generator 151 may be substantially similar or identical to noise components generated by the second ramp generator 152.

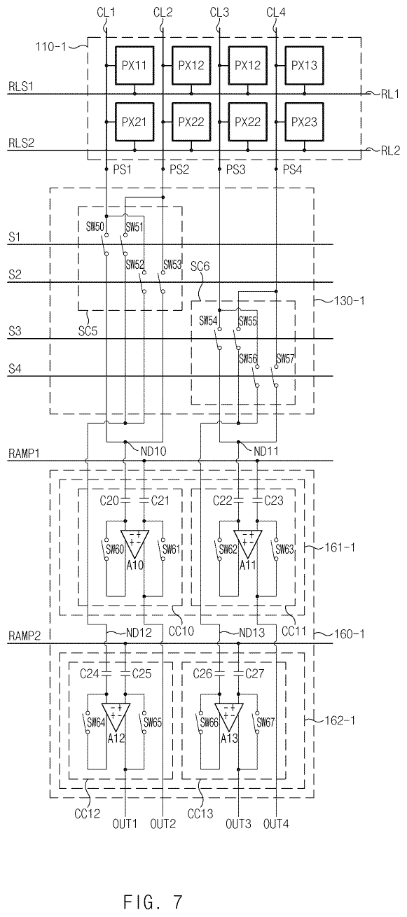

FIG. 7 is a circuit diagram illustrating an example of the pixel array, the column line selector, and the ADC, for example, as included in the image sensing device of FIG. 1.

The circuit of FIG. 7 performs similar operations as the circuits described in FIG. 2 to FIG. 5. Differences between the example of FIG. 7 and FIG. 2 to FIG. 5 are described.

Referring to FIG. 7, the pixel array 110-1 includes a plurality of pixels PX11 to PX14, PX21 to PX24 arranged in the row direction and the column direction. The plurality of pixels PX11 to PX14, PX21 to PX24 is connected to a plurality of row lines RL1, RL2 and a plurality of column lines CL1 to CL4. The plurality of pixels PX11 to PX14 are arranged consecutively in a first row. The plurality of pixels PX21 to PX24 are arranged consecutively in a second row.

In the example of FIG. 7, for convenience of explanation, the pixel array 110-1 is illustrated with two row lines RL1, RL2 and four column lines CL1 to CL4, although the present disclosure is not limited to this example. The quantity of row lines and the quantity of column lines may vary from this example.

The examples of FIG. 3A to FIG. 3D describe a pair of consecutive row decoders activated simultaneously from among the plurality of row decoders 121 to 128. In the example of FIG. 7, the plurality of row decoders 121, 122 may alternatively be activated sequentially, one-by-one, such that the row line selection signals RLS1, RLS2 are activated sequentially. The row lines RL1, RL2 are selected according to activation of the row line selection signals RLS1, RLS2.

For example, when the row line selection signal RLS1 is activated by the row decoder 121, pixels PX11 to PX14 connected to the row line RL1 are selected, and when the row line selection signal RLS2 is activated by the row decoder 122, pixels PX21 to PX24 connected to the row line RL2 are selected.

The pixels PX11, PX21 located in the first column output a pixel signal PS1 through the column line CL1. The pixels PX12, PX22 located in the second column output a pixel signal PS2 through the column line CL2. The pixels PX13, PX23 located in the third column output a pixel signal PS3 through the column line CL3. The pixels PX14, PX24 located in the fourth column output a pixel signal PS4 through the column line CL4.

Because the example of FIG. 7 is configured to output one pixel signal, for example, PS1, per row line based on pixels, such as PX11, PX21, provided in one column or a unit of one column, the method used in the example of FIG. 7 may be referred to as a single readout method.

In the example of FIG. 7, the plurality of row decoders 121 to 128 is sequentially activated. The present disclosure is not limited to this example, and the row decoders 121 to 128 may be selectively activated at random, and the order in which the row decoders 121 to 128 are activated may vary.

The column line selector 130-1 includes a plurality of switching circuits SC5, SC6.

The plurality of switching circuits SC5, SC6 is selectively switched by the plurality of switching control signals S1 to S4 and selectively output the plurality of pixel signals PS1 to PS4 to the first ADC 161-1 or the second ADC 162-1. The plurality of switching circuits SC5, SC6 selectively connects the plurality of column lines CL1 to CL4 to the first ADC 161-1 or the second ADC 162-1 based on the plurality of switching control signals S1 to S4.

Based on the switching control signals S1, S2, the switching circuit SC5 controls a first of a pair of consecutive column lines CL1, CL2 for connection to the first ADC 161-1 and controls a second of the pair of consecutive column lines CL1, CL2 for connection to the second ADC 162-1. The switching circuit SC5 includes a plurality of switching elements SW50 to SW53. The switching element SW50 selectively connects the column line CL1 to node ND10 based on the switching control signal S1, and the switching element SW51 selectively connects the column line CL2 to node ND12 based on the switching control signal S1. The switching element SW52 selectively connects the column line CL1 to the node ND12 based on the switching control signal S2, and the switching element SW53 selectively connects the column line CL2 to the node ND10 based on the switching control signal S2.

Based on the switching control signals S3, S4, the switching circuit SC6 controls a first of a pair of consecutive column lines CL3, CL4 for connection to the first ADC 161-1 and controls the second of the pair of consecutive column lines CL3, CL4 for connection to the second ADC 162-1. The switching circuit SC6 includes a plurality of switching elements SW54 to SW57. The switching element SW54 selectively connects the column line CL3 to node ND11 based on the switching control signal S3, and the switching element SW55 selectively connects the column line CL4 to node ND13 based on the switching control signal S3. The switching element SW56 selectively connects the column line CL3 to the node ND13 based on the switching control signal S4, and the switching element SW57 selectively connects the column line CL4 to the node ND11 based on the switching control signal S4.

The first ADC 161-1 includes a plurality of conversion circuits CC10, CC11. The second ADC 162-1 includes a plurality of conversion circuits CC12, CC13.

The plurality of conversion circuits CC10, CC11 compares the pixel signals applied to the nodes ND10, ND11 with the first ramp signal RAMP1, generates output signals OUT2, OUT4 according to the comparison result, and transmits the output signals OUT2, OUT4 to the counter 163. The plurality of conversion circuits CC12, CC13 compares the pixel signals applied to the nodes ND12, ND13 with the second ramp signal RAMP2, generates the output signals OUT1, OUT3 according to the comparison result, and transmits the output signals OUT1, OUT3 to the counter 163.

The conversion circuit CC10 includes a plurality of capacitors C20, C21, a comparator A10, and a plurality of switching elements SW60, SW61.

The plurality of capacitors C20, C21 is disposed at the input stage of the conversion circuit CC10 to reduce the band of noise received through the node ND10 and the first ramp signal RAMP1.

The comparator A10 compares the pixel signal PS received through the node ND10 with the first ramp signal RAMP1, amplifies the resulting comparison signal, and transmits the output signal OUT2 to the counter 163. The conversion circuit CC10 includes a plurality of switching elements SW60, SW61 utilized to perform the auto-zeroing operation of the comparator A10.

The conversion circuit CC11 includes a plurality of capacitors C22, C23, a comparator A11, and a plurality of switching elements SW62, SW63. The conversion circuit CC12 includes a plurality of capacitors C24, C25, a comparator A12, and a plurality of switching elements SW64, SW65. The conversion circuit CC13 includes a plurality of capacitors C26, C27, a comparator A13, and a plurality of switching elements SW66, SW67. In FIG. 7, the operations of the conversion circuits CC11 to CC13 are performed in a similar manner as the operations of the conversion circuit CC10 are performed.

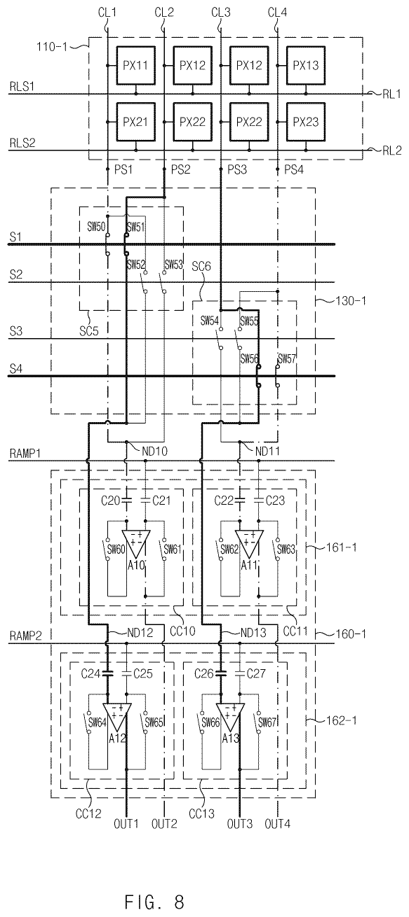

FIG. 8 is a circuit diagram illustrating a column line selector and an ADC, for example, as shown in FIG. 7, during example operations.

Referring to FIG. 8, in a time period where ADC 160-1 is activated, a first pair of switching control signals S1, S4 from among the plurality of switching control signals S1 to S4 is activated and a second pair of switching control signals S2, S3 is deactivated.

The present disclosure is not limited to this example, and a first pair of switching control signals S2, S3 from among the plurality of switching control signals S1 to S4 is activated, while a second pair of switching control signals S1, S4 is deactivated. In the example of FIG. 8, a first pair of switching control signals S1, S4 is activated while a second pair of switching control signals S2, S3 is deactivated.

For example, among the plurality of column lines CL1 to CL4, a pair of consecutive column lines CL1, CL2 is connected to the switching circuit SC5. Among the plurality of column lines CL1 to CL4, a pair of consecutive column lines CL3, CL4 is connected to the switching circuit SC6.

When the switching control signals S1, S4 are activated and the switching control signals S2, S3 are deactivated, the switching elements SW50, SW51, SW56, SW57 are turned on, and the switching elements SW52, SW53, SW54, SW55 are turned off.

Among the pair of column lines CL1, CL2, the column line CL1 is connected to the first ADC 161-1 and the column line CL2 is connected to the second ADC 162-1. Among a pair of column lines CL3, CL4, the column line CL3 is connected to the second ADC 162-1, and the column line CL4 is connected to the first ADC 161-1.

Among a pair of consecutive column lines CL1, CL2, the odd column line CL1 is connected to the first ADC 161-1, and the even column line CL2 is connected to the second ADC 162-1 in the example of FIG. 8. Among a pair of consecutive column lines CL3, CL4, the odd column line CL3 is connected to the second ADC 162-1, and the even column line CL4 is connected to the first ADC 161-1.

The image sensing device according to the present disclosure includes two ramp generators 151, 152 and two ADCs 161-1, 162-1, and a first pixel signal and the first ramp signal RAMP1 received from a first pair of consecutive column lines are transmitted to the first ADC 161-1, or a second pixel signal and the second ramp signal RAMP2 are transmitted to the second ADC 162-1. Accordingly, the first ADC 161-1 and the second ADC 162-1, which receive the two ramp signals RAMP1, RAMP2, are distributed and arranged in a zigzag pattern to reduce horizontal noise.

The examples of the present disclosure can improve noise characteristics of the image sensor by reducing horizontal noise.

Concepts are disclosed in conjunction with examples and embodiments. Those skilled in the art will understand that various modifications, additions, combinations, and substitutions are possible without departing from the scope and technical concepts of the present disclosure. The embodiments disclosed in the present specification should be considered from an illustrative standpoint and not a restrictive standpoint. Therefore, the scope of the present disclosure is not limited to the above descriptions. All changes within the meaning and range of equivalency of the claims are included within their scope.

What is claimed is:

1. An image sensing device comprising:
a pixel array including a plurality of pixels connected to a plurality of row lines and a plurality of column lines and configured to output a plurality of pixel signals through the plurality of column lines;
a ramp generator configured to generate a first ramp signal and a second ramp signal;
an analog-to-digital converter (ADC) configured to convert the plurality of pixel signals into digital signals in response to the first ramp signal and the second ramp signal; and
a column line controller configured to selectively connect the plurality of column lines to the ADC.

2. The image sensing device according to claim 1, wherein the plurality of pixels includes:
a first pixel connected to a first row line of the plurality of row lines and a first column line of the plurality of column lines; and
a second pixel consecutive with the first pixel and connected to a second row line of the plurality of row lines and a second column line of the plurality of column lines;
wherein the first pixel and the second pixel are arranged in a first column.

3. The image sensing device according to claim 2, wherein:
the first column line is arranged on a first side of the plurality of pixels to output a first pixel signal; and
the second column line is arranged on a second side of the plurality of pixels to output a second pixel signal.

4. The image sensing device according to claim 1, wherein the plurality of pixels includes:
a first pixel connected to a first row line of the plurality of row lines and a first column line of the plurality of column lines; and
a second pixel consecutive with the first pixel and connected to the first row line and a second column line of the plurality of column lines,
wherein the first pixel and the second pixel are arranged in a first row.

5. The image sensing device according to claim 1, wherein the ramp generator includes:
a first ramp generator configured to generate the first ramp signal; and
a second ramp generator configured to generate the second ramp signal.

6. The image sensing device according to claim 5, wherein each of the first ramp generator and the second ramp generator includes:
a current generator configured to generate a reference current;
a current controller configured to generate a digital-to-analog conversion (DAC) current based on the reference current;
a voltage converter configured to generate a bias voltage based on the DAC current;
a ramp signal generator configured to generate a ramp signal based on the bias voltage and a switch control signal; and
a resistor circuit configured to control loading of the ramp signal generator.

7. The image sensing device according to claim 1, wherein the ADC includes:
a first ADC configured to sample and hold column lines of a first group selected by the column line controller from among the plurality of column lines and output signals output by the first group;
a second ADC configured to sample and hold column lines of a second group selected by the column line controller from among the plurality of column lines and output signals output by the second group; and
a counter that counts instances of a feature within the signals output by the first group and the signals output by the second group, and outputs the counted features as digital signals.

8. The image sensing device according to claim 7, wherein the column line controller includes a plurality of switching circuits that selectively connects the column lines of the first group to the first ADC and selectively connects the column lines of the second group to the second ADC based on a plurality of switching control signals.

9. The image sensing device according to claim 8, further comprising a column selection controller configured to generate the plurality of switching control signals.

10. The image sensing device according to claim 1, further comprising a plurality of row decoders configured to generate a row line selection signal that activates two consecutive row lines from among the plurality of row lines.

11. An image sensing device comprising:
a first pixel configured to output a first pixel signal through a first column line;
a second pixel configured to output a second pixel signal through a second column line;
a switching circuit that selectively connects, based on a switching control signal, the first column line to one of a first node and a second node and selectively connects, based on the switching control signal, the second column line to one of the first node and the second node;
a first ramp generator configured to generate a first ramp signal;
a second ramp generator configured to generate a second ramp signal;
a first conversion circuit configured to compare the first ramp signal with a signal applied to the first node, amplify a result of the comparison, and generate a first output signal.
a second conversion circuit configured to compare the second ramp signal with a signal applied to the second node, amplify a result of the comparison, and generate a second output signal.

12. The image sensing device according to claim 11, wherein the first pixel is consecutively arranged with the second pixel in a first row.

13. The image sensing device according to claim 11, wherein:
the first pixel is connected to a first row line;
the second pixel is connected to a second row line; and
the first row line and the second row line are activated simultaneously.

14. The image sensing device according to claim 11, wherein the first pixel is consecutively arranged with the second pixel in a first column.

15. The image sensing device according to claim 11, wherein the first pixel and the second pixel are activated simultaneously when the first row line is selected.

16. The image sensing device according to claim 11, wherein each of the first ramp generator and the second ramp generator includes:
a current generator configured to generate a reference current;
a current controller configured to generate a digital-to-analog conversion (DAC) current based on the reference current;
a voltage converter configured to generate a bias voltage based on the DAC current;
a ramp signal generator configured to generate a ramp signal based on the bias voltage and a switch control signal; and
a resistor circuit configured to control loading of the ramp signal generator.

17. The image sensing device according to claim 11, wherein each of the first conversion circuit and the second conversion circuit includes:
a first capacitor arranged to receive a pixel signal and a second capacitor arrange to receive a ramp signal to reduce a band of noise;
a comparator configured to compare a first output from the first capacitor with a second output from the second capacitor, amplify a result of the comparison, and generate an output signal; and
a plurality of switches configured to control an auto-zeroing operation of the comparator.

18. The image sensing device according to claim 11, further comprising a counter that counts instances of a feature within the first output signal and the second output signal, and outputs the counted features as digital signals.

19. The image sensing device according to claim 11, further comprising a column selection controller configured to generate the switching control signal.

20. The image sensing device according to claim 11, further comprising a row driver configured to generate a row line selection signal that selects the first pixel and the second pixel.
